(19) United States
(12) Patent Application Publication
(10) Pub. No.: US 2011/0181885 A1
(43) Pub. Date: Jul. 28, 2011

(54) Large Displacement Micro-Lamellar Grating Interferometer

(75) Inventors: Ying Wen Hsu, San Clemente, CA (US); John C. Carson, Corona del Mar, CA (US); Medhat Azzazy, Laguna Niguel, CA (US)

(73) Assignee: Irvine Sensors Corporation, Costa Mesa, CA (US)

(21) Appl. No.: 13/010,745

(22) Filed: Jan. 20, 2011

Related U.S. Application Data
(60) Provisional application No. 61/336,271, filed on Jan. 22, 2010.

(51) Int. Cl. G01J 3/45

(52) U.S. Cl. 356/452

(57) ABSTRACT

A micro-lamellar grating interferometer for deriving the spectrum of an incident beam from a scene of interest from a generated interferogram is disclosed with a method for using the same.

The interferometer comprises a lamellar grating defined by two interleaved reflective mirror set; a first stationary set of electromagnetically reflective elements and a second moveable set of electromagnetically reflective elements. The first and second set of electromagnetically reflective elements are referred to as mirror elements herein.

The second mirror element set is disposed on a moveable platform supported by flexures that are driven with a high stiffness magnetic, thermal or piezoelectric actuator designed have a predetermined vertical displacement that is perpendicular to the first mirror set.

### CROSS-REFERENCE TO RELATED APPLICATIONS

This application claims the benefit of U.S. Provisional Patent Application No. 61/336,271, filed on Jan. 22, 2010, entitled “Micro Lamellar Grating Interferometer” pursuant to 35 USC 119, which application is fully incorporated herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of interferometry.

More specifically, the invention relates to a micro-lamellar grating interferometer for deriving the spectrum of an incident beam from a scene of interest from a generated interferogram.

2. Description of the Related Art

Military and industrial applications seek a miniature sensor for detection and identification of chemical agents and toxic industrial compounds. A chemical sensor based on lamellar grating spectrometry is well-suited to such applications, especially since lamellar grating spectrometry is highly efficient and when fabricated using Micro-Electro-Mechanical Systems (MEMS) technology, the spectrometer device itself is very small, rugged and uses relatively low power.

Unfortunately, current MEMS-based lamellar interferometer technology cannot meet the high chemical sensor sensitivity needed for the detection of chemical infrared signatures in the LWIR region of about 8-14 μm of the electromagnetic spectrum.

Several technical issues limit the application of MEMS-based lamellar spectrometry for the detection of chemical agents and toxic compounds. These limitations include limited mirror displacement, poor actuator stability, low actuation force and the need for resonant-mode operation

MEMS-based lamellar interferometer has been successfully demonstrated for wavelengths from the visible to near-IR (0.35 to 2.6 μm).

What is needed is a chemical sensor operating from the mid-IR to the LWIR regions (i.e., the range of 3 to 14 μm) with a spectral resolution of at least 100 nm in the LWIR wavelength to accurately identify certain spectra of contaminants. These requirements dictate that in a lamellar interferometer, a grating mirror displacement of approximately 500 μm is necessary. Existing MEMS devices using electrostatic comb drives have displacements ranging only from sub-microns to about 100 μms maximum. For larger mirror displacements, the commonly-used MEMS electrostatic actuators become unstable and the required actuation forces for greater displacement are unattainable.

To overcome the inherently small displacement and low actuation force of electrostatic actuators, prior art MEMS lamellar interferometers amplify mirror displacement by operating in the resonant mode. While using the resonance mode of operation offers certain advantages, resonant systems with large displacements are sensitive to disturbances from shock and vibration.

Prior art lamellar grating interferometers are established devices and infrared absorption spectroscopy is well-established as a reliable technique for detecting and identifying airborne chemicals using the general steps discussed below.

An incident beam of radiation is reflected from an interferometer grating creating an optical path difference between two reflected beams to generate an interference pattern. The resulting interference pattern of the two reflected beams produces an optical signal (i.e., an interferogram) with an intensity that is as a function of the relative vertical displacement of the moveable mirror elements (i.e., using constructive and destructive interference patterns).

By processing the interferogram data and taking its Fourier Transform using suitable processing circuitry, the light power spectra of the incident electromagnetic beam is determined.

Fourier transform spectroscopy (FTS) is a well-developed technique for investigation of the infrared spectra. The two types of FTS interferometers commonly used for IR are the Michelson interferometer and the Lamellar Grating interferometer as are discussed in the literature.

The resulting power spectra are then compared to a lookup library of predetermined electromagnetic spectra of known chemical agents and compounds such as in a database stored in computer memory.

The invention disclosed herein addresses the aforementioned deficiencies in the prior art and provides a MEMS micro-lamellar grating interferometer for the detection of radiation in the mid-wave and long-wave IR range comprising an actuator with high stiffness and high actuation force and that operates the interferometer in the non-resonant mode.

### BRIEF SUMMARY OF THE INVENTION

The interferometer comprises a lamellar grating defined by two interleaved reflective mirror sets; a first stationary set of electromagnetically reflective elements and a second moveable set of electromagnetically reflective elements. The first and second set of electromagnetically reflective elements are referred to as first and second sets of mirror elements herein.

The second mirror element set disposed on a moveable platform supported by flexures and which platform that cooperates with and is driven by an actuator element have a predetermined stiffness. Exemplar actuator elements include, without limitation, magnetic, thermal or piezoelectric actuator assemblies designed provide a predetermined vertical displacement of the second mirror set that is perpendicular to the first mirror set which, in a preferred embodiment is about 500 μm.

In a first aspect of the invention, a micro-lamellar grating interferometer is provided that is fabricated from a MEMS process comprising a lamellar grating comprising a first stationary set of mirror elements and a second moveable set of mirror elements. The first and second set of mirror elements are interleaved whereby the second set of mirror elements may be perpendicularly driven a predetermined distance with respect to the first set of mirror elements and the second set of mirror elements is disposed on a moveable platform driven by at least one MEMS flexure element having a predetermined stiffness. In this configuration, an actuator means is provided for driving the second set of mirror elements perpendicularly with respect to the first set of mirror elements.

In a second aspect of the invention, the actuator means comprises magnetic actuator means.

In a third aspect of the invention, the actuator means comprises thermal actuator means.

In a fourth aspect of the invention, the actuator means comprises piezoelectric actuator means.

In a fifth aspect of the invention, the interferometer further comprises second mirror set position feedback means.

In a sixth aspect of the invention, the thermal actuator means comprises a bi-morph element.

In a seventh aspect of the invention, the piezoelectric actuator means comprises a plurality of stacked piezoelectric disk elements.

In an eighth aspect of the invention, the position feedback means comprises capacitive sensing means.

In a ninth aspect of the invention, the position feedback means comprises inductive sensing means.

In a tenth aspect of the invention, the position feedback means comprises laser reference means.

In an eleventh aspect of the invention, the interferometer further comprising a photo-detector element.

In a twelfth aspect of the invention, the interferometer further comprises circuitry for performing a Fast Fourier Transform.

In a thirteenth aspect of the invention, the interferometer further comprises a gas cell having a predetermined gas sample disposed therein.

In a fourteenth aspect of the invention, a method for identifying the electromagnetic spectrum of a radiation source comprises the steps of providing a micro-lamellar grating interferometer fabricated from a MEMS process comprising a lamellar grating comprising a first stationary set of mirror elements and a second moveable set of mirror elements wherein the first and second set are interleaved whereby the second set may be perpendicularly driven a predetermined distance with respect to the first set.

The second set is driven by flexure element having a predetermined stiffness cooperating with actuator means for driving the second set of mirror elements perpendicularly to the first set of mirror elements. This aspect of the invention comprises the further step of producing a 0^{th} order beam from the radiation source using the micro-lamellar grating interferometer and passing the 0^{th} order beam through a gas cell comprising a predetermined gas to produce a gas cell output and detecting the gas cell output on a photo-detector.

In a fifteenth aspect of the invention, the method further comprises the step of coupling the radiation source with a laser reference source using a first dichroic element to produce a coupled output.

In a sixteenth aspect of the invention, the method further comprises the step of collimating the coupled output prior to producing the 0^{th} order beam.

In a seventeenth aspect of the invention, the method further comprises the step of collimating the 0^{th} order beam.

In an eighteenth aspect of the invention, the method further comprises the step of separating the laser reference source from the collimated 0^{th} order beam using a second dichroic element.

While the claimed apparatus and methods herein has been or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 depicts a cross-section of the moveable and stationary mirror elements of the interferometer of the invention.

FIG. 1A is an interferogram of monochromatic light.

FIG. 2 illustrates a plan view of the interferometer of the invention comprising magnetic actuator means.

FIG. 2A is a perspective view of the interferometer of FIG. 2.

FIG. 3 is a sectional view taken along 3-3 of FIG. 2.

FIG. 4 shows a side view of an alternative embodiment of the interferometer of the invention comprising thermal actuator means.

FIG. 5 is a side view of an alternative embodiment of the interferometer of the invention comprising piezoelectric actuator means.

FIG. 6 illustrates a block diagram of the elements of the spectrometer of the invention.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE INVENTION

Turning now to the figures wherein like numerals define like elements among the several views, a micro-lamellar grating interferometer for deriving the spectrum of an incident beam of electromagnetic radiation from a scene of interest using a generated interferogram and a method for using same are disclosed.

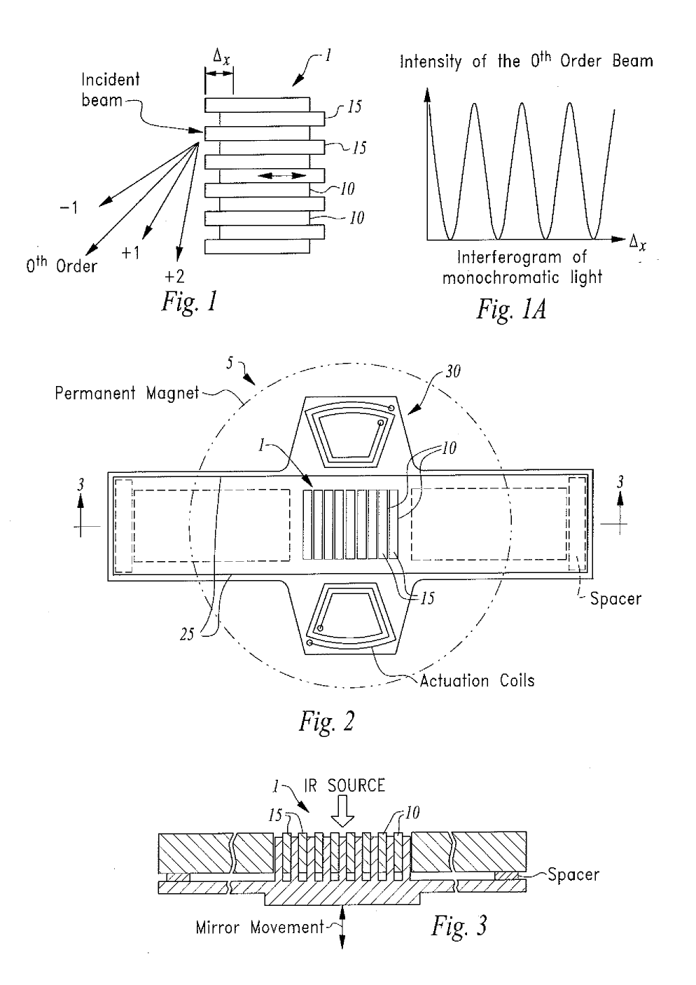

The lamellar grating interferometer was invented by Strong and operates in the 0^{th} order of the grating as shown in FIGS. 1 and 1A.

A brief explanation of the working principles of the device is as follows:

An electromagnetic beam from a scene of interest is incident on the lamellar grating as shown in FIG. 1. By vertically displacing one set of mirror elements while keeping the other set of mirror elements fixed, two electromagnetic beams are reflected from the grating having an optical path difference between them. The two sets of interleaved mirror elements divide the incident electromagnetic beam into two reflected beams; one by the stationary set of mirror elements and the other by the second set of moveable mirror elements. An optical path difference between the two reflected beams is created by the relative vertical displacement of the first and second sets of mirror elements shown as “depth (Δx)” in FIG. 1, resulting in an interference pattern that is a function of Δx.

The intensity of the 0^{t1} order beam is modulated between minimum and maximum as Δx increases. An interferogram is generated by measuring the intensity of the 0^{th} order beam versus Δx. By applying the Fourier Transform to the measured interferogram, the light power spectrum of the incident beam is generated. The resulting power spectrum is compared against known IR spectra of predetermined gases or chemicals stored in an electronic lookup table for identification.

Current MEMS-based lamellar grating interferometers have many deficiencies including the inability to reliably operate outside of the visible and near-IR wavelengths. Further, existing lamellar interferometers are extremely sensitive to shock and vibration such as due to handling or vehicle or aircraft operations.

In contrast to the above deficiencies, the disclosed micro-lamellar grating interferometer has the ability to operate over the infrared spectrum from at least the mid-IR to LWIR where most chemical agents and compounds are known to have strong signatures. Additionally, the disclosed interferometer is ruggedized by having an increased natural resonant frequency; a feature not available in prior art lamellar interferometers.

The approach of the disclosed invention moves away from the resonant mode of operation used by current MEMS interferometers and instead employs an inherently mechanically stiff actuator system, such as a magnetic actuator using an actuation coil and permanent magnet or similar configuration. Desirably, a magnetic actuator can be made small and compact and can achieve resonant frequencies of several KHz (versus a few hundred Hz of the existing MEMS interferometers).

Other types of stiff actuators are within the scope of the invention, including thermal and piezoelectric actuators as further discussed.

The disclosed interferometer uses a hybrid MEMS approach to achieve high resolution interferometry while maintaining small size, ruggedness and low power. Compared to the MEMS lamellar interferometers reported in the literature, the invention herein provides at least the following unique technological advantages:

Ultra-large mirror displacement: The interferometer of the invention has a mirror element displacement of at least 500 μm. Such displacement is considered “ultra-large” for MEMS devices since most MEMS structures are only a few millimeters long and typical relative mirror displacements are only a few to tens of microns.

Sampling in uniform and discrete increments: One of the difficulties with operating a prior art interferometer in the resonant mode is the difficulty in sampling the interferogram signal in uniform and discrete intervals. This difficulty is coupled with the non-linearity of the mirror movement and requires that the interferogram data be pre-processed with special algorithms. The additional data processing introduces errors and reduces system's sensitivity.

On the other hand, the interferometer of the invention operates in the non-resonant mode and allows the interferogram to be taken in pre-determined discrete increments or, for higher data rates, the interferometer of the invention can sample in the continuous mode.

High stiffness interferometer: Another difficulty with operating an interferometer in the resonant mode is that large mirror element displacement reduces system stiffness and lowers the system's natural frequency. An inverse relationship exists between a system's stiffness and displacement. By using an actuator with high stiffness and operating the interferometer in the non-resonant mode, the interferometer of the invention is able to de-couple this fixed relationship and permit both large mirror element displacement and high system stiffness to coexist.

Short response time: Magnetic actuators can respond quickly (i.e., in milliseconds). The fast response of a magnetic actuator allows the interferometer of the invention to incorporate closed-loop position feedback circuitry for precise mirror element positioning and the triggering of detector sampling to produce an interferogram in a short cycle time.

Full IR and high resolution spectrometer: Optical spectroscopy of toxic chemicals from near-IR to LWIR spectrum is possible using the disclosed invention. The spectra produced are high resolution of better than 100 nm (wave number 10 cm⁻¹) in the LWIR spectrum. These capabilities enable development of a new class of miniature chemical sensor for field use with high detection sensitivity.

Miniature size: The small size of the lamellar grating produced using MEMS technology is retained, thus reducing the size of the spectrometer. MEMS processing is exploited to produce the small and precise grating structures. The same process may be used to produce the supporting structures and actuators. With the interferometer reduced in size, other components of the spectrometer are reduced to miniaturize the system.

Rugged system: A small and rugged spectrometer is realized. The low mass of the moveable mirror elements is combined with high stiffness actuators and non-resonant operation which means the overall spectrometer system is truly rugged and deployable in the field.

Low power: The instant interferometer with its low power magnetic actuator ensures low system power consumption and minimizes drain on the battery.

As earlier discussed, lamellar grating interferometry has been used previously for wavelengths in the far infrared (>50 μm) but for shorter wavelengths, the grating structure becomes too fine for conventional machining. However, MEMS technology provides an ideal fabrication process for producing the fine structures required for shorter IR wavelengths measured by the interferometer of the invention.

A summary of key performance specifications for a preferred embodiment of the interferometer of the invention for LWIR wavelengths is as follows:

| | | |
|---|---|---|
| Minimum wavelength | 8 | μm |
| Maximum wavelength | 14 | μm |
| Resolution | 100 | nm (10 cm−1 @ 10 μm) |
| Mirror displacement | 500 | μm |
| Sampling displacement interval | 0.8 | μm |
| Grating period | 36 | μm |
| Resonant Frequency | >1,500 | Hz |

Turning now to FIG. 2, 2A and FIG. 3, a preferred embodiment of the interferometer 5 of the invention generally comprises a lamellar grating 1 defined by two interleaved reflective mirror sets; a first stationary set of electromagnetically reflective (i.e., mirror) elements and a second moveable set of electromagnetically reflective elements.

The first and second set of electromagnetically reflective elements are referred to as first stationary set of mirror elements 10 and second stationary set of mirror elements 15 herein.

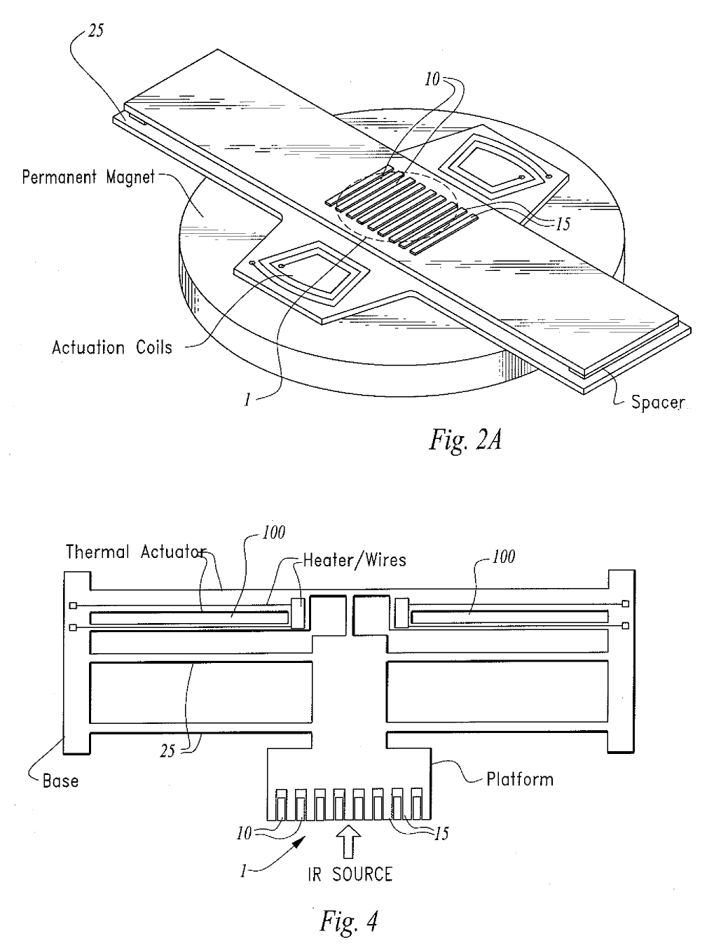

The second mirror element set 15 is disposed on a platform (see, e.g., FIG. 4) that cooperates with and is driven by one or more flexures 25, which platform and flexure are driven in a vertical direction by actuator means 30. A preferred actuator means comprises a high stiffness magnetic actuator means for driving second mirror element 15 set vertically relative to first mirror set 10.

Flexures 25 may be configured as a plurality of cantilevered beams or, as seen in the figures, flexures 25 are a flexure or flexure system with a surface that is substantially coplanar or substantially parallel to the support assembly upon which the first mirror elements are disposed. In a preferred embodiment, flexures 25 are fabricated from a silicon material in a MEMS process and provides a flexure structure that has low hysteresis and yield which is desirable in this application.

Magnetic, thermal or piezoelectric actuator means or other high vertical displacement means are suitable actuator means and are configured to provide a predetermined vertical displacement, i.e., a second mirror set 15 displacement that is substantially perpendicular to first mirror set 10. A preferred embodiment has a relative vertical displacement of about 500 μm.

In a preferred embodiment, the range of wavelengths from 3 to 14 um is selected to cover and to generate an interferogram from about the near to LWIR. Alternatively, the instant device can be designed to cover a broader range of wavelengths such as from visible to LWIR as is known in the field of spectrometry. In selecting the wavelengths, consideration should to be given to the atmospheric transmission (for remote detection), optical component interconnections (optical fiber) and the availability and cost of broadband IR detectors with high sensitivity.

As discussed earlier, a prior art resonant-based system has a fixed relationship between mirror element displacement and system stiffness. The instant interferometer avoids this deficiency and uses a non-resonant system that decouples the system stiffness and displacement. By having a non-resonant system, the actuator has the benefit of high inherent stiffness, or high resonant frequency, and can be used with any actuator means that offers ultra-large displacement and high inherent stiffness.

The high inherent predetermined stiffness of the flexure 25 of the invention permits mirror displacement travel distances unachievable in prior art MEMS-based interferometers that use electrostatic comb drive mechanisms. Prior art electrostatic comb drive mechanisms are typically designed for travel of less than ten microns and travel distances of tens of microns are considered large in comb drive applications. One hundred microns is considered very large travel in a prior art comb drive application.

The disclosed flexure arrangement using magnetic, piezoelectric or thermal actuator means permits a mirror travel distance of about 500 microns which is difficult, if not impossible, to achieve with state of the art comb drive actuators due at least in part to the electrostatic comb drive structure's instability resulting from lateral forces.

Magnetic actuator means for displacement of the second set of moveable mirror elements 15 is well-suited for use in the instant lamellar grating interferometer. Magnetic actuators can be driven to very large displacements and when operating in the close-loop control, the actuator achieves high stiffness.

Advantages of the magnetic actuator include high stiffness, ultra-large displacement, short response time, fine displacement resolution and high actuation force.

As illustrated in FIGS. 2, 2A and the sectional view of FIG. 3, the grating 1 of first and second sets of mirror elements is located in about the center of the device. The two sets of mirror elements are interleaved to form the grating 1. In the illustrated embodiment, the mirror set on the “top” is a stationary mirror set 10 that is supported on a platform. Openings in the first stationary set of mirror elements 10 permits a second moveable set of mirror elements 15 to be slideably interleaved there between to define a lamellar grating 1.

In the illustrated embodiment, the second moveable set of mirror elements 15 is defined on a platform that is supported by flexures 25 on each side of the grating 1. These flexures 25 are precisely etched in a MEMS process and are formed as an integral part of the platform. The flexures 25 ensure precise movement of the second set of moveable mirror elements 15 and can be configured to prevent them from coming in contact with lower surface the first stationary set of mirror elements 10.

In the magnetic actuator embodiment of FIGS. 2 and 2A, the magnetic actuator is defined by a set of actuation coils mounted on the lower surface of the second set of moveable mirror elements 15. The actuation coils are designed to cooperate with a permanent magnet that is positioned at a predetermined distance from the second set of moveable mirror elements 15. When electric current is passed through the actuation coils, the interaction between the current and the magnetic flux produces an electromotive force. The conventional expression for the magnetic force is expressed as:

Fm=I×B

Where Fm is the magnetic force; I is the current and B is the magnetic flux. All three parameters are vectors and the “x” is the cross-product operator. By suitably designing the actuation coil geometry and aligning the permanent magnet, a net force is generated. The magnitude of the force and hence displacement, is controlled by modulating the current flow.

An accurate determination of the second mirror set position over the full length of travel is a consideration for the interferometer in achieving high accuracy. Position feedback may be obtained in several ways including capacitive sensing, inductive sensing from the actuation coils (a stationary coil transmits AC magnetic field is needed) or use of a laser reference system.

Very high forces are achievable using the magnetic actuator (sub-Newtons) embodiment. When combined with a high-bandwidth closed-loop control system, the system's natural frequency reaches several KHz.

In another embodiment, thermal actuator means provides an alternative moveable mirror set displacement means with high force and high displacement actuation. The thermal actuator embodiment takes advantage of the dissimilar expansion of two parallel beams 100 to produce a “bi-morph” element bending.

In the thermal actuator embodiment of FIG. 4, the tip of the bending beams in the thermal actuator achieves large vertical displacements. The two beams 100 are designed with different widths, producing different rates of thermal conduction. The resulting difference in the thermal gradients produces the bending of beams 100. An integral heater is provided on the thermal actuators to provide a means for introduction and control of the heat source. To actuate the second set of moveable mirror elements 15, an electrical current is passed through the heaters located on the thermal actuators.

As before, the lamellar grating 1 of the thermally-actuated embodiment is formed by two interleaved first stationary and second moveable sets of mirror elements. The second set of moveable mirror elements 15 is connected to a structure such as a platform supported by and driven by a pair of parallel flexures. The structure cooperates with and is driven by the thermal actuators. The first stationary set of mirror elements 10 is fixed to the substrate and is interleaved with the second set of moveable mirror elements 15.

Thermal actuators provide high displacement and high stiffness but unlike magnetic actuators, these two design parameters are not decoupled. In practice, the design of the actuator geometry is driven by actuation force and displacement and once these requirements are met, the stiffness of the actuators is fixed. Although optimization of the design can provide some compromise between displacement and stiffness, the de-coupling of these parameters is limited in this embodiment.

A potential issue with thermal actuators is that the performance is sensitive to the thermal environment. Depending on the method of mounting and packaging chosen for device, the actuator displacement can vary as the temperature of the substrate changes. Careful design of the actuator and device packaging ensures consistent performance.

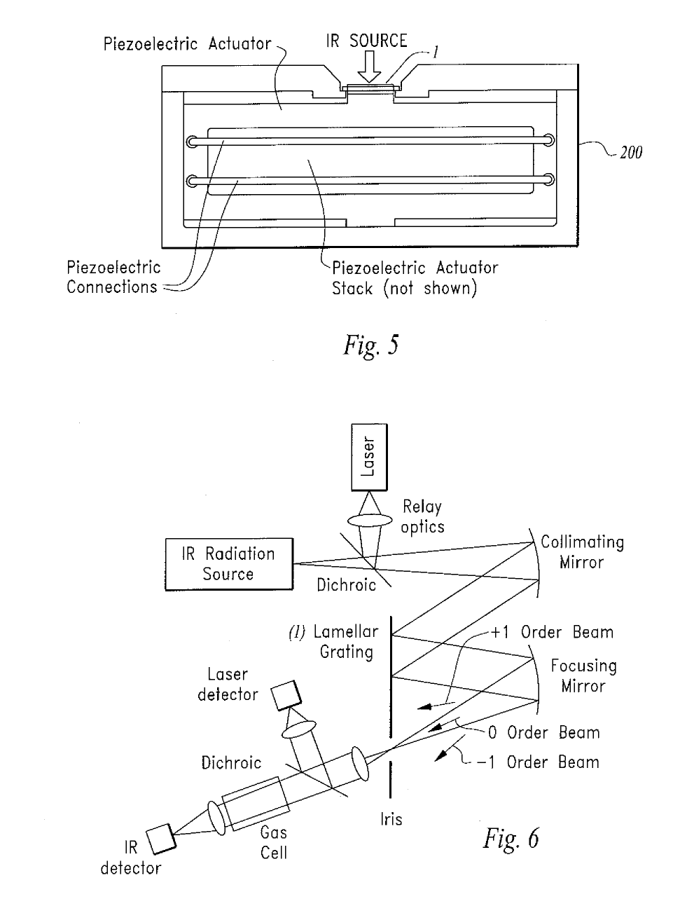

Yet a third preferred embodiment for producing an ultra-large displacement and high stiffness system is by using piezoelectric actuators as depicted in FIG. 5.

Chip scale integration of MEMS and piezoelectric actuators has been demonstrated at low displacements but displacements in the range of 500 μm require a large number of piezoelectric disks, making this embodiment difficult to achieve using chip scale integration in this embodiment. The alternative to chip scale integration is the use of commercially available miniature piezoelectric actuators.

Commercially available piezoelectric actuators are designed with a stack of piezoelectric disks integrated in a flexure frame for precise movement. An example of a suitable piezoelectric actuator means is the FlexFrame PiezoActuator (TM) family of actuators produced by Dynamics Structures & Materials, LLC (Franklin, Tenn.). Depending on the size, these miniature actuators produce a displacement in excess of 500 μm. These piezoelectric actuators are relatively large compared to magnetic and thermal actuators, with the largest dimensions of a 500 μm actuator currently measuring about 46 mm×16 mm.

In addition to the ultra-large displacement, the piezoelectric actuators have very high stiffness. For actuators with a 500 μm movement, the stiffness is on the order of sub- to several Newtons per μm.

In the piezoelectric embodiment of FIG. 5, an external support frame 200 may be used to support the stationary element of the grating 1, with the piezoelectric actuator attached to the second set of moveable mirror elements 15. The overall size of the device in this exemplar embodiment measures approximately 51 mm×22 mm (2.0 in×0.9 in).

A related issue with the piezoelectric embodiment shown in FIG. 5 is the sensitivity of the system to temperature changes. With the external frame and the piezoelectric actuator supporting different parts of the mirrors, any mismatch in the thermal expansion or contraction may cause a misalignment of the mirror sets, thus reducing the intensity of the interferometer. The effect of the mismatch can potentially be reduced by careful design and software compensation.

FIG. 6 shows a schematic diagram of a lamellar grating interferometer system that takes advantage of the instant invention. A radiation source is coupled with a reference laser beam (acting as a reference signal) using a dichroic filter and is collimated using a collimating mirror. The collimated light is then received and reflected by the lamellar grating 1. The reflected light from the grating is focused using a focusing mirror.

The diffracted light passes through an iris which separates the 0^{th} order diffraction from the higher and lower orders. The reflected 0^{th} order beam is then collimated. The IR radiation is separated from the reference laser wavelength using another dichroic filter. The collimated IR radiation then propagates through a gas cell that contains the predetermined sample gas and the transmitted light is detected using an IR detector.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. A micro-lamellar grating interferometer fabricated from a MEMS process comprising:
a lamellar grating comprising a first stationary set of mirror elements and a second moveable set of mirror elements,
the first and second set of mirror elements interleaved whereby the second set of mirror elements may be perpendicularly driven a predetermined distance with respect to the first set of mirror elements,
the second set of mirror elements driven by a flexure element having a predetermined stiffness,
actuator means for driving the flexure element and second set of mirror elements perpendicularly with respect to the first set of mirror elements.

2. The interferometer of claim 1 wherein the actuator means comprises magnetic actuator means.

3. The interferometer of claim 1 wherein the actuator means comprises thermal actuator means.

4. The interferometer of claim 1 wherein the actuator means comprises piezoelectric actuator means.

5. The interferometer of claim 1 further comprising second mirror set position feedback means.

6. The interferometer of claim 3 wherein the thermal actuator means comprises a bi-morph element.

7. The interferometer of claim 4 wherein the piezoelectric actuator means comprises a plurality of stacked piezoelectric disk elements.

8. The interferometer of claim 5 wherein the position feedback means comprises capacitive sensing means.

9. The interferometer of claim 5 wherein the position feedback means comprises inductive sensing means.

10. The interferometer of claim 5 wherein the position feedback means comprises laser reference means.

11. The interferometer of claim 1 further comprising a photo-detector element.

12. The interferometer of claim 1 further comprising circuitry for performing a Fast Fourier Transform.

13. The interferometer of claim 1 further comprising a gas cell having a predetermined gas sample.

14. A method for identifying the electromagnetic spectrum of a radiation source comprising the steps of:
providing a micro-lamellar grating interferometer fabricated from a MEMS process comprising a lamellar grating comprising a first stationary set of mirror elements and a second moveable set of mirror elements wherein the first and second set of mirror elements are interleaved whereby the second set of mirror elements may be perpendicularly driven a predetermined distance with respect to the first set of mirror elements,
the second set of mirror elements cooperating with and driven by a flexure element having a predetermined stiffness and further comprising actuator means for driving the second set of mirror elements perpendicularly with respect to the first set of mirror elements,
producing a 0^{th} order beam from the radiation source using the micro-lamellar grating interferometer,
passing the 0^{th} order beam through a gas cell comprising a predetermined gas to produce a gas cell output,
detecting the gas cell output on a photo-detector.

15. The method of claim 14 further comprising the step of coupling the radiation source with a laser reference source using a first dichroic element to produce a coupled output.

16. The method of claim 15 further comprising the step of collimating the coupled output prior to produce the 0^{th} order beam.

17. The method of claim 16 further comprising the step of collimating the 0^{th} order beam.

18. The method of claim 17 further comprising the step of separating the laser reference source from the collimated 0^{th} order beam using a second dichroic element.
